(19) United States
(12) Patent Application Publication
(10) Pub. No.: US 2025/0215984 A1
(43) Pub. Date: Jul. 3, 2025

(54) CHECK VALVE AND COMPACT PUMP SYSTEM

(71) Applicant: Equilibar, LLC, Fletcher, NC (US)

(72) Inventors: Jeffrey Dean Jennings, Hendersonville, NC (US); Ryan Matthew Heffner, Asheville, NC (US); Carlyle Leonard Donevant, IV, Asheville, NC (US)

(21) Appl. No.: 18/851,314

(22) PCT Filed: Mar. 28, 2023
(86) PCT No.: PCT/US23/65046

§ 371 Date: Sep. 26, 2024

Related U.S. Application Data
(60) Provisional application No. 63/324,969, filed on Mar. 29, 2022.

(51) Int. Cl. F16K 15/02; F16K 15/14

(52) U.S. Cl. CPC F16K 15/023; F16K 15/142

(57) ABSTRACT

A check valve includes: an inlet housing and extending between a first end defining an inlet of the valve, and a second end, the second end including a baffle having a plurality of inlet orifices passing therethrough; an outlet housing and extending between a first end defining an outlet of the valve and a second end, wherein the second ends cooperate to define a valve chamber; a closure element disposed in the chamber movable between a first position in which it engages the baffle, preventing flow from the inlet to the outlet, and a second position where the closure element is disengaged from the baffle, permitting flow from the inlet to the outlet; and wherein the closure element includes opposed inlet and outlet faces and a plurality of flow passageways interconnecting the inlet and outlet faces are disposed at an outer periphery of the closure element.

### CROSS-REFERENCE TO RELATED APPLICATIONS

This application claims the benefit of provisional patent application 63/324,969 filed Mar. 29, 2022, which is incorporated by reference herein.

### BACKGROUND OF THE INVENTION

The present invention relates to fluid pumps, and more particularly to compact pumps for laboratory or similar systems.

Peristaltic (or tubing) pumps are the most popular option for moving liquids in the laboratory environment. They are simple and cost effective and are used for applications requiring no significant pressure build (<1 psi) up to pressures in the range of 20-40 psig. Disadvantages are periodic replacement of worn tubing, and severe pulses, which can sometimes affect downstream processes—especially in the biopharma world where chromatography and ultrafiltration can be degraded or damaged by pressure pulses.

Another popular option for pumps in the laboratory processes are diaphragm pumps. Advantages are more reliable performance over time, stronger pressure outputs. These pumps are more expensive, especially for single use processes where the entire pump head has to be disposed of. They also have severe pulsations coming from a single or dual head, though additional heads (e.g., 3, 4, or even 5 heads) are sometimes used to minimize pulsations to the process. Quatroflow pumps are a leader in expensive biopharma processes due to the reduction of pulsations, though certain biopharma applications continue to suffer from pulsation damage to sensitive cells and cell components. However, these multi-head pumps are extremely expensive and bulky. They can be supplied with “single use” models, though these are also relatively high expense.

Both pumps mentioned above have some flow metering capabilities. However, increasingly in modern biopharma and chemical processes, flow meters are used to provide feedback to the pumps to provide more reliable measurement over time and varying process parameters.

Many single use pumps are used in biopharma in the range of 1 to 2 bar, though most single use components are rated up to 4 bar. Many lab and single use applications do not require significant pressure outputs, and could easily accommodate a pump capable of output in the range of 0.3 bar or less. Some biopharma processes use pressures of up to 6 bar.

What is needed is an additional option for pumping fluids that:
minimizes the wetted components that must be disposed of;
reduces the space requirements inside the critical process system;
is capable of pumping liquids and slurries in lab processes with minimal pulsations; and
can be sterilized by ionizing radiation, chemical, or physical means for biopharma production.

### BRIEF SUMMARY OF THE INVENTION

This need is addressed by a pump incorporating a flexible wetted channel in a housing, fluidly coupled to a pulsation driver.

According to one aspect of the technology described herein, A check valve, including: an inlet housing having a first flow cavity and extending between a first end defining an inlet of the valve, and a second end, the second end including a baffle having a plurality of inlet orifices passing therethrough; an outlet housing having a second flow cavity and extending between a first end defining an outlet of the valve and a second end, wherein the second ends of the inlet housing and the outlet housing cooperate to define a valve chamber; a closure element disposed in the chamber movable between a first position in which it engages the baffle, preventing flow from the inlet to the outlet, and a second position where the closure element is disengaged from the baffle, permitting flow from the inlet to the outlet; and wherein the closure element includes opposed inlet and outlet faces and a plurality of flow passageways interconnecting the inlet and outlet faces are disposed at an outer periphery of the closure element.

According to another aspect of the technology described herein, a pump apparatus includes: a pump chamber having a flexible wetted channel disposed inside a housing, such that a outer chamber is defined between the wetted channel and the housing, an inlet check valve disposed at a first end of the flexible wetted channel, and an outlet check valve disposed at a second end of the flexible wetted channel; a pulsation driver; and a fluid circuit interconnecting the pulsation driver and the outer chamber, the fluid circuit containing a secondary fluid, wherein the pulsation driver operable to impart cyclic pressure pulsations in the secondary fluid.

### BRIEF DESCRIPTION OF THE DRAWINGS

The invention may be best understood by reference to the following description taken in conjunction with the accompanying drawing figures in which:

FIG. 1 is a schematic diagram of a first exemplary embodiment of a pump apparatus;

FIG. 2 is a schematic diagram of a second exemplary embodiment of a pump apparatus;

FIG. 3 is a schematic diagram of a third exemplary embodiment of a pump apparatus;

FIG. 4 is a schematic diagram of a fourth exemplary embodiment of a pump apparatus;

FIG. 5 is a schematic diagram of an alternative pump chamber;

FIG. 6 is a perspective view of a check valve;

FIG. 7 is an exploded view of the check valve of FIG. 6;

FIG. 8 is a perspective view of a closure element of the check valve of FIG. 6;

FIG. 9 is a plan view of the closure element of FIG. 6; and

FIG. 10 is a cross-sectional view of the check valve of FIG. 6;

### DETAILED DESCRIPTION OF THE INVENTION

Described herein are several example embodiments of an apparatus which includes a pump chamber having a flexible wetted inner element positioned inside a housing. The pump chamber has a minimal amount of wetted components, saving space and reducing disposal cost.

This pump chamber utilizes flexible tubing (or bellows) as a compressible section in combination with two, three or more check valves.

Optionally, this pump apparatus may utilize higher frequency pulsations, higher than 240 cycles/minute (a speed greater than used by most peristaltic pumps) to minimize the size of pulsations. A higher preferred embodiment uses greater than 600 cycles/minute to achieve desired throughput while further reducing the amplitude of pulsations.

In each mention of flexible tubing or “an inner tube”, it will be understood that a bellows-style flexible element could be substituted. Generically, for the purposes of this description, the inner tube or the bellows-style flexible element define “a flexible wetted channel”.

The examples shown below illustrate single chamber pumps. An additional embodiment is multiple chamber pumps (N chambers), N+1 check valves would be used. In such pumps, secondary fluid pressure are higher in successive chambers. In a preferred embodiment, the pulsations are timed such that the maximum pressure first occurs in the early stage and then passes to successive chambers, similar to the function of the mammal heart.

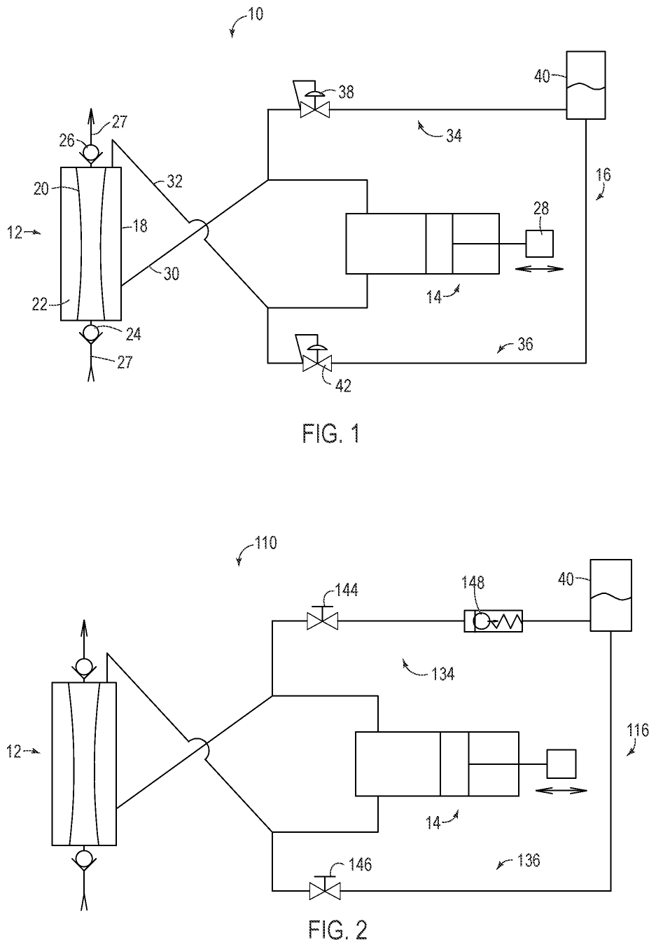

Now, referring to the drawings wherein identical reference numerals denote the same elements throughout the various views, FIG. 1 illustrates an exemplary embodiment of pump apparatus 10. It includes a pump chamber 12 operably connected to a pulsation driver 14 by a fluid circuit 16. Preferably, the pulsation driver should be configured such that its generating mechanism has an odd number of pulsating elements. Due to superposition of the oscillation waves, an odd number of pulsation elements ensures that constructive interference (which would amplify pulsations) is not realized.

The pump chamber 12 includes a housing 18. The housing 18 is made from a relatively rigid material, “rigid” being defined in this con text as a material stiff enough not to have significant deflection at system pressures. Nonlimiting examples of suitable rigid materials include high-density polyethylene (HDPE), polyethylene (PE), polypropylene (PP), polycarbonate (PC), as well as metals such as stainless steel 316L. Preferably, the material can be sterilized by ionizing radiation, chemical, or physical means for biopharma production.

An inner tube 20 is disposed inside the housing 18. In use, a process fluid (alternatively referred to herein as a “primary fluid”) passes through the interior of the inner tube 20.

The inner tube 20 is made from a flexible material, “flexible” being defined in this context as a material soft enough to deflect at system pressures. Various materials can be considered for the inner tube 20, depending on the pressure rating. Preferably, the material can be sterilized by ionizing radiation, chemical, or physical means for biopharma production.

The housing 12 and the inner tube 20 are arranged such that a closed volume referred to as an “outer chamber” 22 is defined between the interior surface of the housing 18 and the exterior surface of the inner tube.

An inlet check valve 24 is disposed in or near the upstream end of the inner tube 20 (i.e. the lower end as drawn). The function of the inlet check valve 24 is to permit primary fluid flow into the inner tube 20 but prevent it from flowing outwards. An outlet check valve 26 is disposed at or near the downstream end of the inner tube 20 (i.e. the upper end as drawn). The function of the outlet check valve 26 is to permit primary fluid flow out of the inner tube 20 but prevenst it from flowing inwards. The inlet and outlet check valves 24, 26 are coupled in fluid communication with a process flow system 27 containing a process (or primary) fluid.

The tubing and check valves could be disposable for single use, or the entire pump chamber 12 could alternatively be considered single use. Or the pump chamber 12 could be used for other applications other than single use.

It will be understood that the pump chamber 12 is configured such that introducing a positive pressure of secondary fluid into the outer chamber 22 will compress the inner tube 20, expelling primary fluid contained therein from the outlet check valve 26. Conversely, introducing a negative pressure of secondary fluid into the outer chamber 22 will expand the inner tube 20, drawing primary fluid into the inner tube 20. Repeating the cycle establishes a flow of primary fluid through the pump chamber 12.

These check valves are preferably of a design to minimize back flow (minimal backlash), as discussed below.

The pulsation driver 14 is operable to move a secondary fluid in the fluid circuit 16 to ultimately compress and expand the inner tube 20. Stated another way, the pulsation driver 14 is operable to impart cyclic pressure pulsations in the secondary fluid. The pulsation driver 14 is depicted in the drawing as a piston or a diaphragm pump mechanism with a reciprocating mechanism 28 such as a linear actuator or motor and crank mechanism, though the pulsation driver 14 could be other mechanisms as well.

The fluid circuit 16 carries a secondary fluid (e.g. incompressible fluid such as distilled water) between the pulsation driver 14 and the pump chamber 12. In this particular example, the fluid circuit 16 is a circulating fluid circuit which is capable of controlling both the maximum pressure and the suction pressure on the pump chamber 12. First and second lines 30, 32 respectively are connected to the housing 18 to control the degree to which air bubbles are present (though these could be joined before the housing 18 for convenience if air bubbles can be precluded from the system to the desired degree).

In this example, the first line 30 is coupled to a portion of the fluid circuit 16 referred to as a “upper circuit” 34 and the second line 32 is coupled to a portion of the fluid circuit 16 referred to as a “lower circuit” 36.

A pressure relieving valve (“PRV”) or back pressure regulator 38 is coupled to the upper circuit 34 to specifically define the maximum pulsation pressure relative to atmosphere, if needed. Fluid from this upper circuit 34 can be stored in an accumulator 40 (either pressurized or vented), for use by the suction control system.

A vacuum regulator (“VR”) 42 is supplied on the lower circuit 36 to fix the suction pressure of the pump chamber 12. This can be important to assure that the inner tube 20 opens enough during the suction stroke, lowering the secondary fluid below that of the available suction head of the process system. When the suction reaches the target pressure (relative to atmosphere, positive or negative), the VR 42opens and introduces fluid from the accumulator 40. Such a cycling of fluid creates a natural mass balance and becomes steady state. The greater the volumetric displacement of the pulsation driver 14 (i.e., greater than the pump chamber stroke capacity), the greater the flow around this circuit. If the pump chamber 12 becomes dead headed or more restricted in volumetric output, then the upper circuit 34 moves more fluid to the accumulator 40. At the same time, the reduced compression of the inner tube 20 will mean that the suction stroke will quickly require replenishment from the lower circuit 36.

This embodiment provides very explicit pressure control at the cost of more complexity, and could be desirable where pressure control and NPSH control is needed. These regulators (PRV and VR) can be simple manual spring devices, or one or both of them could be dome loaded pressure regulators to allow for sophisticated computer automation of pump flow/pressure profile.

FIG. 2 illustrates an alternative embodiment of a pump apparatus 110. It includes a pump chamber 12 operably connected to a pulsation driver 14 by a fluid circuit 116. Portions of the pump apparatus 110 not explicitly described may be taken to be identical to corresponding components in the pump apparatus 10 of FIG. 1.

In this embodiment, a simpler arrangement is shown where fluid restrictions are depicted by first and second adjustable valves 144, 146 are shown coupled in the upper and lower circuits 134, 136 respectively. The function of these adjustable valves 144, 146 could easily be represented by orifices or even restricted tubing diameters. Such fluid restrictions will define on a relative basis the differential flow/pressure profile going to the pump housing 18, though the performance of the system will be less explicitly defined and more tuned for each application. For example, for a given housing geometry and suction and output pressure environment, it is possible to tune the valves 144, 146 to perform well. In order to provide a fluid circuit moving in the directions shown to prevent air build up in the pump housing (upper circuit 134 to right, lower circuit 136 to left), some form of check valve or one-way valve will be required in the fluid circuit 116. A check valve 148 is depicted in the upper circuit 134, though this could also be located in the lower circuit 136 (coming out of the bottom of the accumulator 40). The check valve 148 could be of a low or higher differential pressure (spring loaded is depicted). The check valve 148 could replace the adjustable valve 144, 146 on either circuit, especially if it is a restricting check valve and/or a spring loaded check valve.

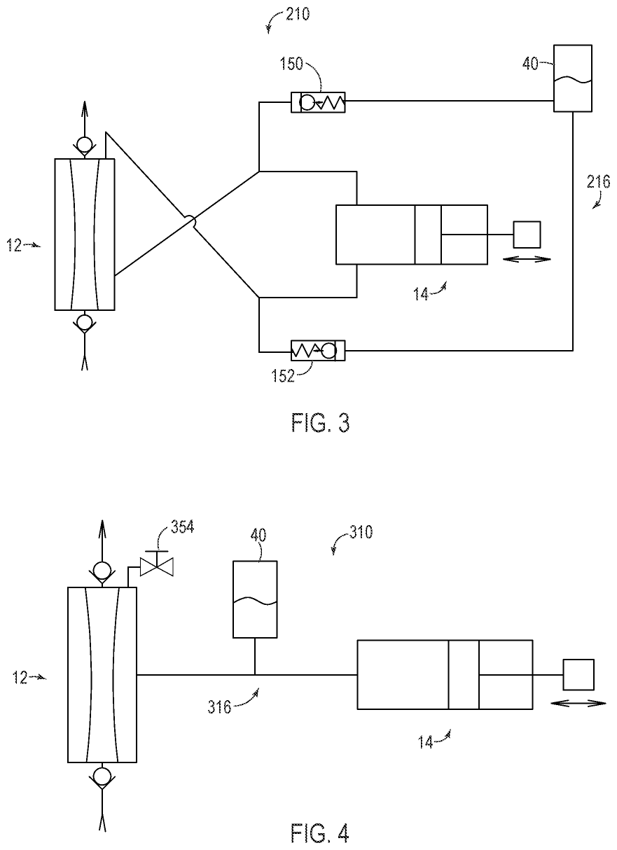

FIG. 3 illustrates an alternative embodiment of a pump apparatus 210. It includes a pump chamber 12 operably connected to a pulsation driver 14 by a fluid circuit 216. Portions of the pump apparatus 210 not explicitly described may be taken to be identical to corresponding components in the pump apparatus 10 of FIG. 1.

This embodiment is similar to the embodiment shown in FIG. 1, and includes optional accumulator 40, though the PRV and VR are replaced by spring loaded check valves 150, 152 (or similar devices that are designed to provide differential pressure P1 and P2 without regard to atmospheric pressure). These devices provided the necessary checking action to keep the circuit flowing in the correct direction, but also provide the desired level of differential pressure to define the maximum pulsation amplitude of the pump. Because these devices are not referencing atmosphere, this system provides amplitude control, not explicit pressure control in gauge pressure. As discussed above relative to the embodiment of FIG. 2, such a simpler system can be preferable for many applications where the volumes and pressures are well matched to the application requirements.

FIG. 4 illustrates an alternative embodiment of a pump apparatus 310. It includes a pump chamber 12 operably connected to a pulsation driver 14 by a fluid circuit 316. Portions of the pump apparatus 310 not explicitly described may be taken to be identical to corresponding components in the pump apparatus 10 of FIG. 1.

In this embodiment, no pressure controls are provided, but the pulsation driver 14 is simply connected to the pump chamber 12. An optional accumulator 40 is shown to aid in filling, and an optional air release valve 354 is provided coupled to the housing 18. An air release valve (not shown) may also be provided at the pulsation driver 14.

One potential complication with using water as the secondary fluid is concern about intermingling of non-sterile water with biopharma fluids in the event of a tubing or bellows burst. An option, therefore, is to surround the inner tube 20 of any the embodiments described above with an exceptionally soft elastomer such as a Shore A20 or softer elastomer, with preferred hardness Shore A10 or less. Medical grade silicones and industrial silicones could suffice. Pressure waves could be applied to the soft elastomer through mechanical means such as a diaphragm or bellows or piston or vibrating head. The soft elastomer would serve to isolate the critical fluids from the source of pulsation.

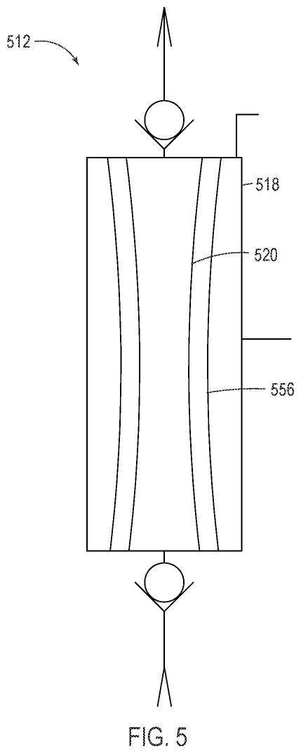

FIG. 5 illustrates an alternative pump chamber 512 that may be substituted for the pump chamber 12 in any the embodiments shown in FIGS. 1-4 above. It includes an inner tube 520 in a housing 518. A separate sleeve 556 separates the secondary fluid from the inner tube 520, such that any leak in either the inner tube 520 or the sleeve 556 would result in an external leak between the sleeve 556 and inner tube 520. Pulses and pressure from the secondary fluid are transferred through the sleeve 556 into the inner tube 520, while preserving the evidence of any leak, and precluding the possibility of cross contamination.

An ideal check valve for the pump chamber 12 described above would have the following properties:
minimum backflow;
optimized open area-to-nominal area ratio (whereas the nominal area is defined as the cross sectional area using the maximum wetted flow path diameter); and
minimal cracking pressure (differential pressure at both low flow and nominal flow rates).

In a simple analysis of check valve geometry, the back flow can be considered to be the projection of the area of all the valve orifices multiplied by the axial distance that the closure element travels at the nominal flow rate. For example, for a ball check with 0.3 inch valve seat, and where the ball moves forward by 0.12 inch to achieve he nominal flow rating of the valve, the first-principle back flow would be the area of the 0.3 inch hole multiplied by the 0.12 inch axial travel.

Several types of commercially available to valves are suitable for the pump chamber described herein. Examples include: duckbill, ball check poppet check, and diaphragm style.

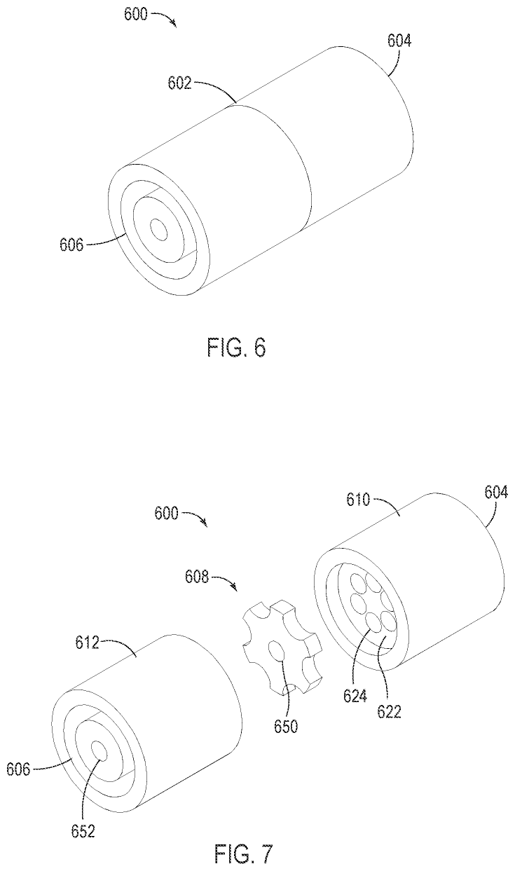

As an alternative to existing check valve types, FIGS. 6-10 illustrate an exemplary check valve 600 configured to have the desirable properties described above. The check valve 600 has a housing assembly 602 defining an inlet 604 and an outlet 606, with a closure element 608 disposed inside the housing assembly 602. In this example, the housing assembly 602 has a simple cylindrical shape, but other shapes could be used.

The housing assembly 602 comprises an inlet housing 610 and an outlet housing 612. The housing assembly 602 is made from a relatively rigid material, as described above. Preferably, the material can be sterilized by ionizing radiation, chemical, or physical means for biopharma production.

The inlet housing 610 comprises a peripheral wall 614 extending from a first end 616 to a second end 618 and defining a flow cavity 620. The inlet 604 of the check valve 600 is disposed at the first end 616 of the inlet housing 610. A baffle 622 is disposed near the second end 618 of the inlet housing 610. The baffle 622 is recessed a short distance to accommodate the closure element 608.

The baffle 622 has a plurality of inlet orifices 624 passing therethrough.

A preferred embodiment is a single circular pattern of 5 to 7 inlet orifices 624, with 6 being the most highly preferred number.

The outlet housing 612 comprises a peripheral wall 626 extending from a first end 628 to a second end 630 and defining a flow cavity 632. The outlet 606 of the check valve 600 is disposed at the first end 628 of the outlet housing 612. A centerbody 634 is disposed in the flow cavity 632. The centerbody 634 is connected to the peripheral wall 626 by one or more struts 636.

The second ends 618 and 630, respectively, of the inlet housing 610 and the outlet housing 612 cooperate to define a valve chamber 638 which receives the closure element 608.

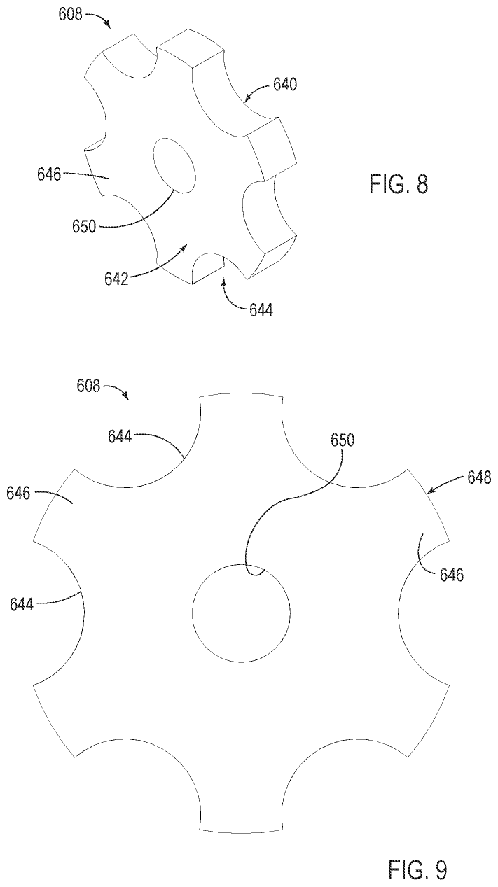

The closure element 608 is shown in more detail in FIGS. 8 and 9. The closure element 608 is generally of uniform thickness having a planar inlet face 640 and an opposed outlet face 642, in the illustrated example, some or all of the outer periphery of the closure element 608 is of a cylindrical shape. Optionally, open-ended cutouts or flow passageways 644 are formed at the outer periphery of the closure element 608. In the illustrated example, the flow passageways 644 of an arcuate shape. The non-cutaway portions define arms 646 with bearing surfaces 648 disposed at the full nominal outside diameter to provide alignment of the closure element within the valve chamber 638. A highly preferred embodiment is between 5 and 7 passageways separated by arms 646; the most preferred number of flow passageways 644 is 6. The closure element 608 may include a center hole 650 to provide for maximum outflow.

The shape and dimensions of the valve chamber 638 are complementary to those of the closure element 608 so as to providing for both support of the closure element 608 to limit travel, and to allow the alignment of the flow passageways 644 to the outlet 606 with minimal restriction. For example, both the valve chamber 638 and the bearing surfaces 648 may be cylindrical. The bearing surfaces 648 may have a outside diameter slightly smaller than an inside diameter of the valve chamber 638. If the closure element 608 includes a center hole 650, then the outlet housing 612 may be provided with a matching central bore 652 passing axially through the centerbody 634 and aligned coaxially with the center hole 650.

In the illustrated example, the inlet housing 610 and the outlet housing 612 may be provided as separate elements which are connected or joined to each other by means such as a mechanical joint, a threaded joint, adhesive bonding, thermal bonding, sonic welding, or friction welding.

Alternatively, some or all of the housing assembly 602 may be manufactured as a unitary, integral, or monolithic structure using additive manufacturing methods (e.g., “3D printing”).

Alternatively, some or all sub-components of the inlet housing 610 and/or the outlet housing 612 may be provided as separate elements to permit insertion and assembly of the closure element 608.

Optionally, the entirety of the check valve 600 may be manufactured using additive manufacturing methods.

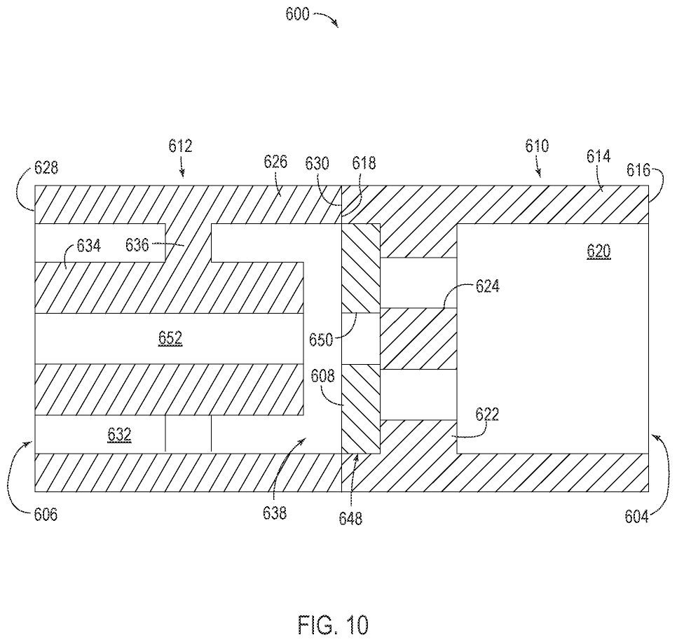

The closure element 608 is disposed in the valve chamber 638. It is movable between a first, closed position (shown in FIG. 10) in which it abuts the baffle 622 and seals off the inlet orifices 624, and a second, open position in which it is spaced away from the baffle 622, permitting flow through the inlet orifices 624.

The example design depicted in the drawings has an inlet orifice flow area approximately 29% (+/−2%) of nominal area and outlet area approximately 31% (+/−2%) of nominal area.

A most preferred geometric embodiment provides for inlet orifices 624 between 0.18 and 0.23 of nominal diameter (6 each) (0.2 to 0.22 most preferred). The inlet orifices 624 are arranged on a base circle diameter of between 0.48 and zero.55 of nominal diameter (0.5 to 0.53 most preferred). The flow passageways 644 of the closure element 608 are designed to avoid intersecting with the inlet orifices 624. The center hole 650, if present, may be of a similar size to that of one of the individual inlet orifices 624.

For best performance, the axial travel of the closure element 608 should be limited to a range of 0.2 to 0.35 of the inlet orifice diameter, with a preferred embodiment between 0.25 and 0.33 of that diameter. Smaller travels than this second range may provide for reduced backlash but at the expense of increased fluid pressure drop.

The resulting backflow of this exemplary design is less than 1.6%×ND×(Pi×ND\hat{ } 2/4), and preferably below 1.3%×ND×(Pi×ND\hat{ } 2/4), where ND is the nominal diameter of the valve chamber 638. The ratio of (backflow volume) divided by (total cross sectional area of the inlet orifices 624) is less than 0.08/ND, and is preferably less than 0.06/ND. This defines the efficiency of the design to both minimize backflow while also minimizing diameter and pressure drop.

The closure element 608 could be a thin film such as a flexible polymer film, or it could also be a stiffer polymer (e.g., thermoplastic polyurethanes (TPU)), or even metallic material. Flexible films will provide better shut-off. Optional O-rings (not shown) can be fitted in the inlet orifices 624 if desired. Preferably, the material can be sterilized by ionizing radiation, chemical, or physical means for biopharma production. The best flexible polymer diaphragm would be one that matches the body material for ideal thermal (or other method) welding conditions. A thin flexible diaphragm would ensure fast action during checking scenarios, and the high frequency environment of the check action for generating flow will be best supported by flexible but robust polymer welds, when applicable.

The apparatus described above has numerous advantages over prior art single-use pump systems. It is compact, low-cost, and has minimal wetted components.

The foregoing has described a pump apparatus and a check valve therefore. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

1. (canceled)

2. The check valve of claim 3, wherein the outlet housing includes a centerbody disposed in the second flow cavity, the centerbody supported by a plurality of struts within the second flow cavity.

3. A check valve, comprising:
an inlet housing having a first flow cavity and extending between a first end defining an inlet of the valve, and a second end, the second end including a baffle having a plurality of inlet orifices passing therethrough;
an outlet housing having a second flow cavity and extending between a first end defining an outlet of the valve and a second end, wherein the second ends of the inlet housing and the outlet housing cooperate to define a valve chamber;
a closure element disposed in the chamber movable between a first position in which it engages the baffle, preventing flow from the inlet to the outlet, and a second position where the closure element is disengaged from the baffle, permitting flow from the inlet to the outlet; and
wherein the closure element includes opposed inlet and outlet faces and a plurality of flow passageways interconnecting the inlet and outlet faces are disposed at an outer periphery of the closure element, wherein the flow passageways alternate with arms having bearing surfaces disposed at an outside diameter thereof, the bearing surfaces sized to align the closure element within the valve chamber.

4. The check valve of claim 3, wherein the flow passageways have a cylindrical shape.

5. A check valve, comprising:
an inlet housing having a first flow cavity and extending between a first end defining an inlet of the valve, and a second end, the second end including a baffle having a plurality of inlet orifices passing therethrough;
an outlet housing having a second flow cavity and extending between a first end defining an outlet of the valve and a second end, wherein the second ends of the inlet housing and the outlet housing cooperate to define a valve chamber;
a closure element disposed in the chamber movable between a first position in which it engages the baffle, preventing flow from the inlet to the outlet, and a second position where the closure element is disengaged from the baffle, permitting flow from the inlet to the outlet, wherein a center hole is formed through the closure element; and
wherein the closure element includes opposed inlet and outlet faces and a plurality of flow passageways interconnecting the inlet and outlet faces are disposed at an outer periphery of the closure element.

6. The check valve of claim 5, wherein:
the outlet housing includes a centerbody disposed in the second flow cavity;
the centerbody includes a central bore passing therethrough; and
the center hole of the closure element is aligned coaxially with the central bore.

7. The check valve of claim 5, wherein a distance provided for axial travel of the closure element within the valve chamber is a range of 0.2 to 0.35 of the diameter of the inlet orifices.

8. (canceled)

9. A pump apparatus, comprising:
a pump chamber having a flexible wetted channel disposed inside a housing, such that a outer chamber is defined between the wetted channel and the housing, an inlet check valve disposed at a first end of the flexible wetted channel, and an outlet check valve disposed at a second end of the flexible wetted channel;
a pulsation driver; and
a fluid circuit interconnecting the pulsation driver and the outer chamber, the fluid circuit containing a secondary fluid, wherein the pulsation driver is operable to impart cyclic pressure pulsations in the secondary fluid, wherein the fluid circuit includes an accumulator.

10. (canceled)

11. A pump apparatus, comprising:
a pump chamber having a flexible wetted channel disposed inside a housing, such that a outer chamber is defined between the wetted channel and the housing, an inlet check valve disposed at a first end of the flexible wetted channel, and an outlet check valve disposed at a second end of the flexible wetted channel;
a pulsation driver; and
a fluid circuit interconnecting the pulsation driver and the outer chamber, the fluid circuit containing a secondary fluid, wherein the pulsation driver is operable to impart cyclic pressure pulsations in the secondary fluid;
wherein the fluid circuit includes an upper circuit coupled to the outer chamber by a first line, and a lower circuit coupled to the outer chamber by a second line; and
wherein the upper circuit includes a pressure regulating valve and the lower circuit includes a vacuum regulator.

12. The pump apparatus of claim 11, wherein at least one of the upper circuit and the lower circuit includes an adjustable valve.

13. The pump apparatus of claim 11, wherein at least one of the upper circuit and the lower circuit includes a check valve.

14. The pump apparatus of claim 11, wherein the pump chamber includes a sleeve disposed between the wetted inner channel and the housing.

15. The pump apparatus of claim 11, wherein the pulsation drive has an odd number of pulsating elements.

16. The check valve of claim 5, wherein the outlet housing includes a centerbody disposed in the second flow cavity, the centerbody supported by a plurality of struts within the second flow cavity.

17. The check valve of claim 5, wherein the flow passageways have a cylindrical shape.

18. The check valve of claim 3, wherein:
the outlet housing includes a centerbody disposed in the second flow cavity;
the centerbody includes a central bore passing therethrough; and
the closure element has a center hole formed therein aligned coaxially with the central bore.

19. The check valve of claim 3, wherein a distance provided for axial travel of the closure element within the valve chamber is a range of 0.2 to 0.35 of the diameter of the inlet orifices.

20. The pump apparatus of claim 11, wherein the fluid circuit includes an accumulator.

21. The pump apparatus of claim 9, wherein the pump chamber includes a sleeve disposed between the wetted inner channel and the housing.

22. The pump apparatus of claim 9, wherein the pulsation drive has an odd number of pulsating elements.
